(19) United States
(12) Patent Application Publication
(10) Pub. No.: US 2007/0100857 A1
(43) Pub. Date: May 3, 2007

(54) Computer-implemented method, tool, and program product for storing a business document in an enterprise software application environment

(75) Inventors: Ross DeGrande, Ocean, NJ (US); Nancy L. Friedman, Apex, NC (US); Garfield W. Vaughn, South Windsor, CT (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/263,316

(22) Filed: Oct. 31, 2005

(51) Int. Cl. G06F 7/00

(52) U.S. Cl. 707/101

(57) ABSTRACT

In general, the present invention provides a computer-implemented method, system, tool, and program product for storing a document in an enterprise software environment, such as SAP. Specifically, under the present invention, a hierarchical structure is provided for linking a business document. The hierarchical structure includes a plurality of levels that each represent a business entity level such as enterprise, company, customer, contract and revision. Additionally, standardized attributes may be chosen for association with the business document. The invention also provides a search engine for searching for a document that has previously been linked to the hierarchical structure. These searches may be performed using such factors as the level in the hierarchy and/or the specified attributes.

### FIELD OF THE INVENTION

The present invention generally relates to storage of documents. Specifically, the present invention provides a tool for hierarchically storing and retrieving business documents in an enterprise software application environment.

### BACKGROUND OF THE INVENTION

The business world of today is becoming increasingly more complicated. Inventory, human resources, accounting functions, and business relationships and communications with other businesses are among the myriad of factors that must be successfully dealt with in running a business. Because of this, access to and organization of information is a must in the modern business world.

Enterprise software provides one way of keeping track of the information necessary to run a business effectively. One example of an enterprise software application is Systems, Application and Products (SAP) from SAP® AG of Walldorf, Germany. Enterprise software applications such as SAP provide customers with the ability to interact with a common corporate database for a comprehensive range of applications that may be used to run a business. These enterprise software applications provide the capability to manage financial, asset, and cost accounting, production operations and materials, personnel, plants, and archived documents. To this extent, enterprise software provides a single resource for managing diverse aspects of a business.

One of the specific functions provided by enterprise software is the ability to store documents related to a business. This document storage feature provides a central location for all of the documents that relate to the business. A business document stored using the document storage feature may relate to various aspects of the business and may be in any of a variety of formats, such as word processing, spreadsheet, text, graphics, audio, and video, to name a few. The enterprise software may also allow a user to enter a text string that may be linked to the document. This text string may be used as an attribute for retrieving the document.

However, the typical enterprise software has several deficiencies in its document storage feature. Specifically, the lack of underlying structure for linking to the document makes it so that logically related documents are not linked in any way and are thus difficult to determine from the enterprise software, itself. Furthermore, a document that relates to a parent business entity and a number of dependent business entities may have to be saved multiple times with each instance linked to a different business entity. This could lead to data consistency problems if one or more of the documents is modified while one or more are not. Still further, the fact that only a single attribute may be entered may limit the criteria that may later be used to search for the document. Additionally, the user's ability to enter any text string makes it more difficult to later find documents having related attributes for which a user may have entered different text strings.

In view of the foregoing there exists a need for a tool that overcomes the above-referenced deficiencies.

### SUMMARY OF THE INVENTION

In general, the present invention provides a computer-implemented method, system, tool, and program product for storing a document in an enterprise software environment, such as SAP. Specifically, under the present invention, a hierarchical structure is provided for linking a business document. The hierarchical structure includes a plurality of levels that each represents a business entity level such as enterprise, company, customer, contract and revision. Additionally, standardized attributes may be chosen for association with the business document. The invention also provides a search engine for searching for a document that has previously been linked to the hierarchical structure. These searches may be performed using such factors as the level in the hierarchy and/or the specified attributes.

A first aspect of the present invention provides a computer-implemented method for storing a business document in an enterprise software application environment, comprising: providing a hierarchical structure, the hierarchical structure having a plurality of levels, wherein each level represents a business entity level; providing an interface for accessing the hierarchical structure; linking, using the interface, the business document with a business entity in the level in the hierarchical structure corresponding to the business document; and allowing assignment of attributes that are not related to the level to the business document.

A second aspect of the present invention provides a system for storing a business document in an enterprise software application environment, comprising: a hierarchical structure having a plurality of levels, wherein each level represents a business entity level; an interface for accessing the hierarchical structure; means for linking, using the interface, the business document with a business entity in the level in the hierarchical structure corresponding to the business document; and means for assigning attributes to the business document that are not related to the level.

A third aspect of the present invention provides a program product stored on a computer readable medium for storing a business document in an enterprise software application environment, the computer readable medium comprising program code for causing a computer system to perform the following steps: provide a hierarchical structure, the hierarchical structure having a plurality of levels, wherein each level represents a business entity level; provide an interface for accessing the hierarchical structure; link, using the interface, the business document with a business entity in the level in the hierarchical structure corresponding to the business document; and allow assignment of attributes that are not related to the level to the business document.

A fourth aspect of the present invention provides a method for deploying an application for storing a business document in an enterprise software application environment, comprising: providing a computer infrastructure being operable to: provide a hierarchical structure, the hierarchical structure having a plurality of levels, wherein each level represents a business entity level; provide an interface for accessing the hierarchical structure; link, using the interface, the business document with a business entity in the level in the hierarchical structure corresponding to the business document; and allow assignment of attributes that are not related to the level to the business document.

A fifth aspect of the present invention provides computer software embodied in a propagated signal for storing a business document in an enterprise software application environment, the computer software comprising instructions for causing a computer system to perform the following steps: providing a hierarchical structure, the hierarchical structure having a plurality of levels, wherein each level represents a business entity level; providing an interface for accessing the hierarchical structure; linking, using the interface, the business document with a business entity in the level in the hierarchical structure corresponding to the business document; and allowing assignment of attributes that are not related to the level to the business document.

Therefore, the present invention provides a computer-implemented method, tool, and program product for storing a document in an enterprise software environment.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for storing a business document in an enterprise software application environment according to the present invention.

FIG. 2 shows an illustrative view of a hierarchical structure according to the present invention.

FIG. 3 shows an illustrative view of a hierarchical structure having linked business documents according to the present invention.

FIGS. 4-7 show illustrative electronic views according to the present invention.

FIG. 8 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a computer-implemented method, system, tool, and program product for storing a document in an enterprise software environment, such as SAP. Specifically, under the present invention, a hierarchical structure is provided for linking a business document. The hierarchical structure includes a plurality of levels that each represent a business entity level such as enterprise, company, customer, contract and revision. Additionally, standardized attributes may be chosen for association with the business document. The invention also provides a search engine for searching for a document that has previously been linked to the hierarchical structure. These searches may be performed using such factors as the level in the hierarchy and/or the specified attributes.

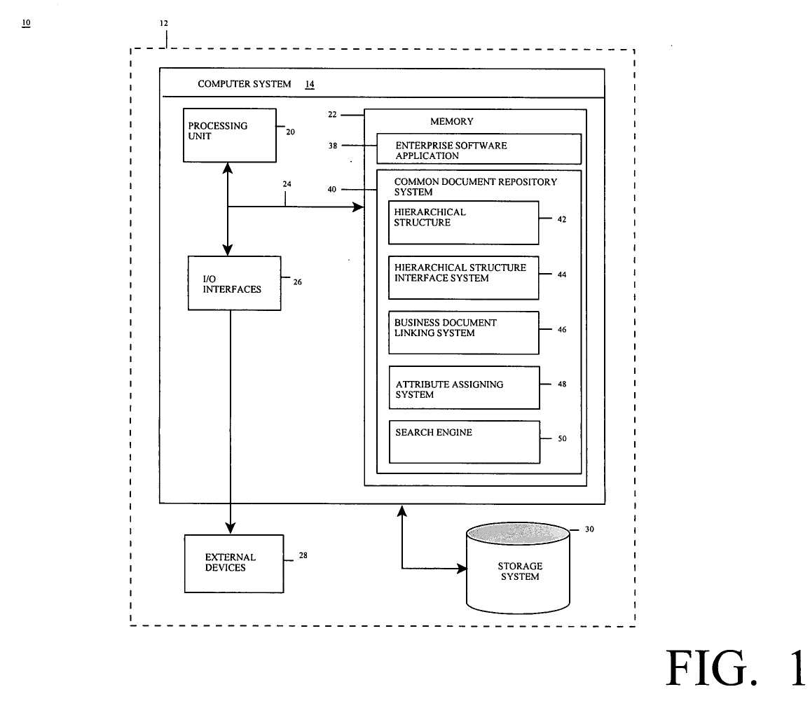

Referring now to FIG. 1, a system 10 for storing a business document in an enterprise software application environment according to the present invention is shown. Specifically, FIG. 1 depicts a system 10 for storing a business document in which the business document is linked with a hierarchical structure. System 10 also allows descriptive attributes to be assigned to the business document. In addition, system 10 allows the business document to be retrieved based on searches of the hierarchical structure and/or the assigned attributes. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to store a document for use in an enterprise software environment.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as instant message reply system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as business documents, hierarchical structures, attribute lists, security profiles, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 are an enterprise software application 38 and a common document repository system 40, which is a software program that will provide the functions of the present invention. Enterprise software application 38 is an application, such as SAP, that provides customers with the ability to interact with a common corporate database for a comprehensive range of applications that may be used to run a business. As such, enterprise software application 38 provides an environment within which common document repository system 40 may be run. For example, common document repository system 40 may be fully or partially incorporated within enterprise software application 38. In the alternative, common document repository system 40 may be a stand-alone application that operates within the environment created by the enterprise software. Still further, all or a portion of common document repository system 40 may be formed using a macro language that forms a part of enterprise software application 38.

In any case, common document repository system 40 provides a system for storing a business document in the environment of enterprise software application 38. To this extent, common document repository system includes a hierarchical structure 42, a hierarchical structure interface system 44, a business document linking system 46, an attribute assigning system 48, and, optionally, a search engine 50.

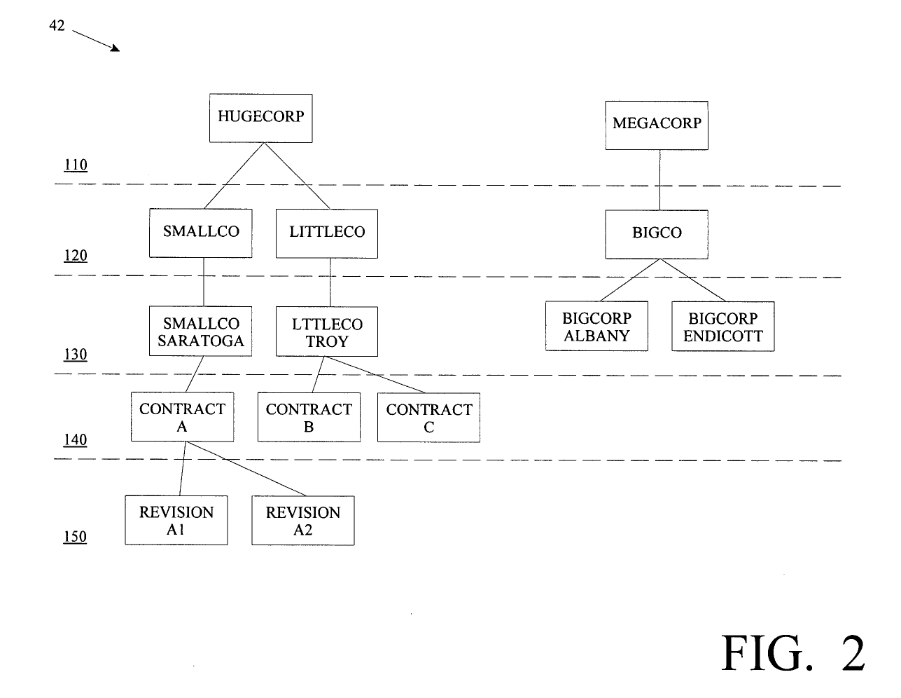

Referring now to FIGS. 1 and 2, collectively, hierarchical structure 42 of common document repository system 40 will be described in more detail. In summary, hierarchical structure 42 provides a structure to which a business document may be linked. In this manner, a single document may be associated with multiple business entities with a single link.

FIG. 2 shows an exemplary hierarchical structure 42 according to the present invention. Hierarchical structure 42 has an enterprise level 110, a company level 120, a customer level 130, a contract level 140, and a revision level 150. As shown in FIG. 2, each level 110, 120, 130, 140 and 150 has a number of business level entities, which are represented in FIG. 2 with boxes. There are two enterprises in enterprise level 110 of the exemplary hierarchical structure 42, namely Hugecorp and Megacorp. Smallco, Littleco and Bigco are shown in company level 120 of hierarchical structure 120 with Smallco and Littleco being companies of the Hugecorp enterprise and Bigco being a company of the Megacorp enterprise. At customer level 130, Bigco is shown as having two customers, Bigco Albany and Bigco Endicott, while Smallco and Littleco are shown as having one customer apiece, namely, Smallco Saratoga and Littleco Troy, respectively. Smallco Saratoga is shown as having a single contract, Contract A, in contract level 140 while Littleco Troy is shown as having two, Contract B and Contract C. In revision level 150, only contract A is shown as having revisions, namely Revision A1 and Revision A2.

Returning to FIG. 1, hierarchical structure interface system 44 of common document repository system 40 provides an interface for accessing hierarchical structure 42. Hierarchical structure interface system 44 may allow a user to access all or a portion of hierarchical structure 42. To this extent, a user may use hierarchical structure interface system 44 to view a graphical depiction that allows the user to access the business entities in all or a portion of enterprise level 110, company level 120, customer level 130, contract level 140 and revision level 150 of hierarchical structure 42.

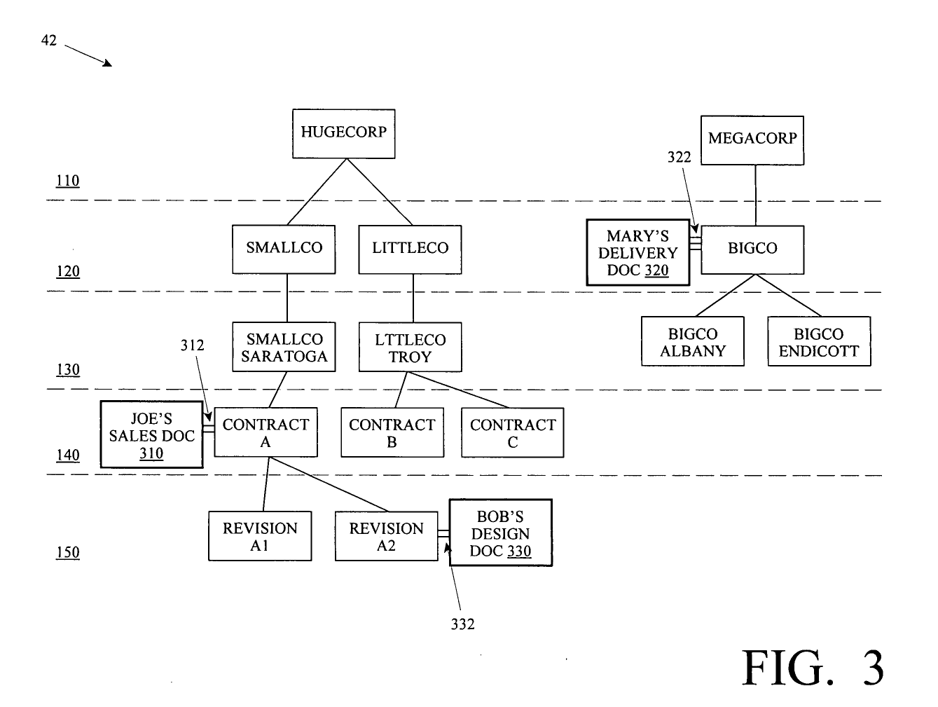

Referring now to FIGS. 1 and 3 collectively, business document linking system 46 provides a way to link a business document with a business entity in level 110, 120, 130, 140, and 150 in hierarchical structure 42 that corresponds to the business document. The linking performed by business document linking system 42 may be accomplished using input from hierarchical structure interface system 44 or in any way now known or later developed for linking a business document with a hierarchical structure. In this way, a business document that is linked a business entity on a particular level 110, 120, 130, 140, and 150 of hierarchical structure 42 has a relationship with the business entity in the level 110, 120, 130, 140, and 150 to which it has been linked as well as any dependent business entities.

For example, referring now to FIG. 3, a number of business documents 310, 320 and 330 are shown to be linked to business entities of hierarchical structure 42 using links 312, 322 and 332, respectively. As illustrated, a business document labeled Joe's Sales Doc 310 is linked 312 with Contract A, in contract level 140 of hierarchical structure 42. In this arrangement, link 312 causes Joe's Sales Doc 310 to have a relationship not only with Contract A, but also Revision A1 and Revision A2 of revision level 150, which depend from Contract A. Similarly, a business document labeled Mary's Delivery Doc 320 that is linked 322 with Bigco in company level 130 also has a relationship with Bigco Albany and Bigco Endicott in customer level 120, as well as any non-illustrated (or subsequently created) business entities in contract level 140 and revision level 150 that may depend from Bigco. In contrast, a business document labeled Bob's Design Doc 330 that is linked 332 with Revision A2 in revision level 150 is related only to Revision A2 because no other business entities depend from Revision A2.

Referring again to FIG. 1, attribute assigning system 48 of common document repository system 40 provides a way for assigning and/or modifying one or more attribute of the business document being linked with hierarchical structure 42. The assigning of attributes performed by attribute assigning system 48 may be accomplished using hierarchical structure interface system 44 or in any way now known or later developed for assigning an attribute to a business document. Attributes comprise key words and/or phrases that identify the nature of the business document independent of the level of the document in hierarchical structure 42. Examples of attributes may include an area of business represented by the business document, a location of the office in which the document was drafted or received, an owner of the business document, a title of the business document, a function of the business document, etc. For example, in Joe's Sales Doc 310 (FIG. 3) may have a title attribute of “Joe's Sales Doc,” an owner attribute of “Joe,” and/or a business area attribute of “sales.” Some or all of the attribute values that are allowed by attribute assigning system 48 are preferably standardized to insure that like business documents have like attributes for searching purposes. For example, the attribute called business area may allow only the following values: sales (order invoice, email communication between sales rep and customer, anything that says I need X), delivery (specs of the network, things that will help setting up service, deliverables), solution design (internal communications with the technical personnel to solve the problem, regarding physical requirement for achieving the solution, establish service parameters), and network.

Common document repository system 40 may also include search engine 50 for searching for and/or retrieving a business document that previously has been linked to hierarchical structure 42 using business document linking system 46. Search engine 50 may be accessed from hierarchical structure interface system 44 or in any way now known or later developed for searching for a business document within a hierarchical structure. Search engine 50 may search for a business document using one or more search values based on a factor that is related to level 110, 120, 130, 140 and 150 of the business document. For example, referring again to FIG. 3, search engine 50 may be used to search for all business documents associated with Revision A2 in revision level 150, using all or a part of the name Revision A2, some identifier associated with Revision A2, or other method known in the art. In this example search engine 50 would return Bob's Design Doc 330 linked 332 to Revision A2 in revision level 150 as well as Joe's Sales Doc 310 linked 312 to Contract A in contract level 140 because Revision A2 depends from Contract A.

Additionally, or in the alternative, search engine 50 may search hierarchical structure 42 for a business document based on attributes that previously have been assigned to the business document using attribute assigning system 48. To this extent, referring again to the example in FIG. 3, search engine 50 may be used to search hierarchical structure 42 for all business documents having a business area attribute of delivery and an owner attribute of Mary, returning Mary's Deliver Doc 320.

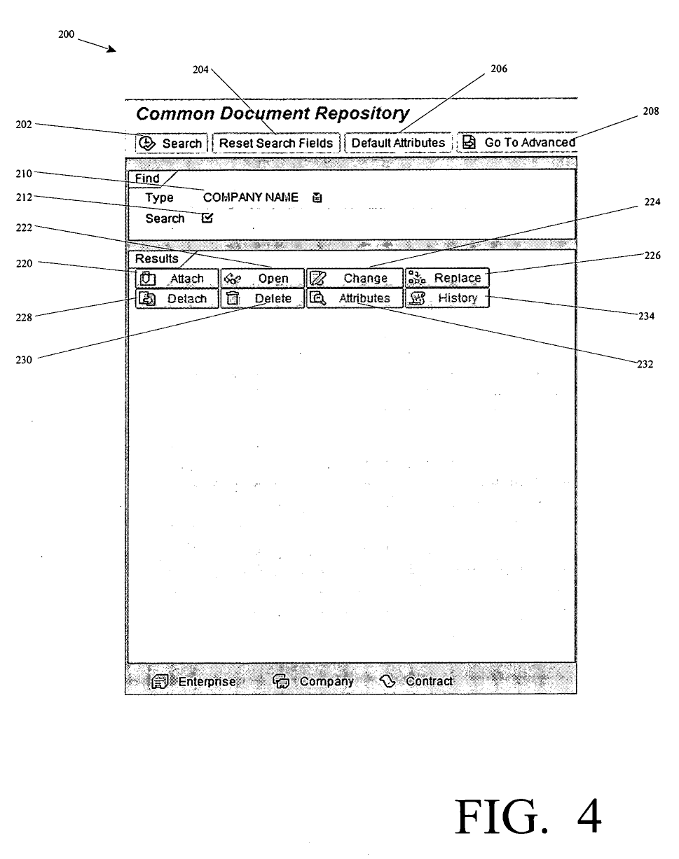

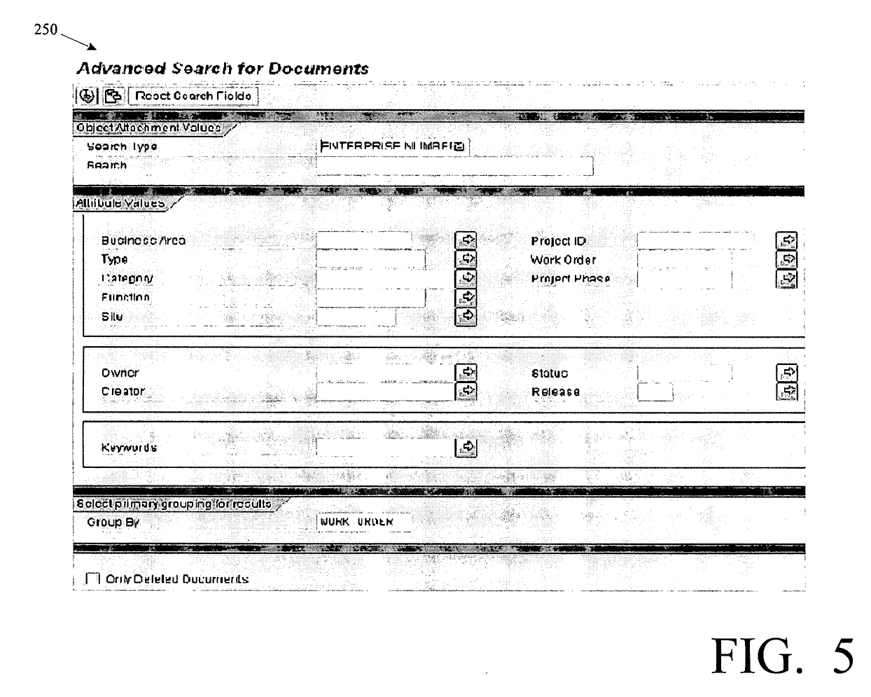

FIGS. 4-7 provide examples of one embodiment for using a user interface such as may be provided by hierarchical structure interface system 44 (FIG. 1) for accessing hierarchical structure 42 (FIGS. 1-3), linking a business document with hierarchical structure 42 (FIG. 3), searching hierarchical structure for a business document, etc. FIG. 4 shows a combined interface 200 for common document repository system 40. Combined interface 200 may be reached through enterprise software application 38 such as via a control button, menu, etc., or, in the alternative, may be reached from another application or run as a stand-alone application. In any event, combined interface 200 has a find section in which a search may be specified and a results section in which results of a search may be displayed and/or modified as necessary. To perform a search using combined interface 200 a user must first specify a search type 210 and enter a search string 212. Search type 210 indicates the parameter type (e.g., level in hierarchical structure 42, attribute) for performing the search while search string 212 indicates the specific value for which the search will be performed. Once the user has provided values for search type 210 and search string 212, the user may activate search button 202 to initiate a search. In the alternative, the user may activate a reset search fields button 204 to clear the information which the user has previously entered. Alternatively, the user may activate a go to advanced button 208 to display an advanced search options form 250 such as is shown in FIG. 5. Note that advanced search options form 250 allows a user to search for a business document using a variety of parameter type simultaneously.

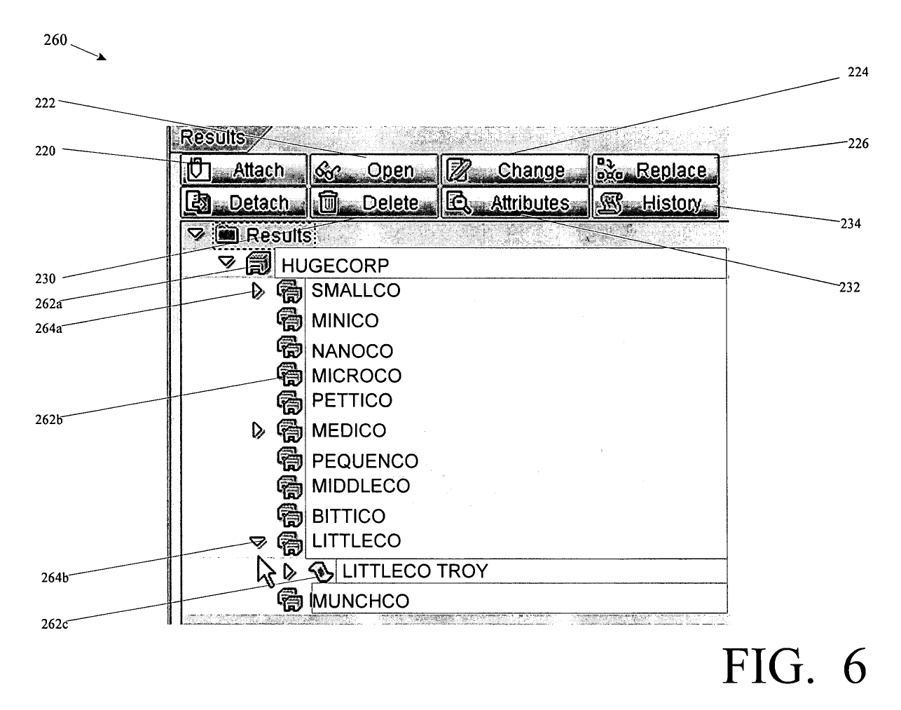

FIG. 6 shows sample results 260 from a search using combined interface 200. Sample results 260 may return an entire hierarchy or subset of the hierarchy of a business entity found in the search, or, in the alternative, may return only the business entity or business document found by the search. In this exemplary embodiment, the sample results 260 includes a graphical representation of a hierarchy that include a number of business entities (e.g., 262a, 262b, 262c) from a number of levels. In addition, sample results 260 includes expansion/contraction arrows 264a, 264b which allow the user to further expand or contract the user's view of the hierarchy.

Once sample results 260 have been retrieved, the user may perform specific functions on a particular business entity 262a, 262b, 262c and/or business document. For example, a business document may be linked with a particular business entity (e.g., 262a, 262b, 262c) in sample results 260 using business document linking system 46 (FIG. 1) by activating an attach function button 220. Conversely, a link between a business document and a business entity (e.g., 262a, 262b, 262c) may be terminated by activating a detach function button 228. Furthermore, a particular business document may be opened, changed, replaced and/or deleted using an open function button 222, a change function button 224, a replace function button 226 and a delete function button 230, respectively. Still further, a history function button 234 may be used to display a history of the business entity or business document.

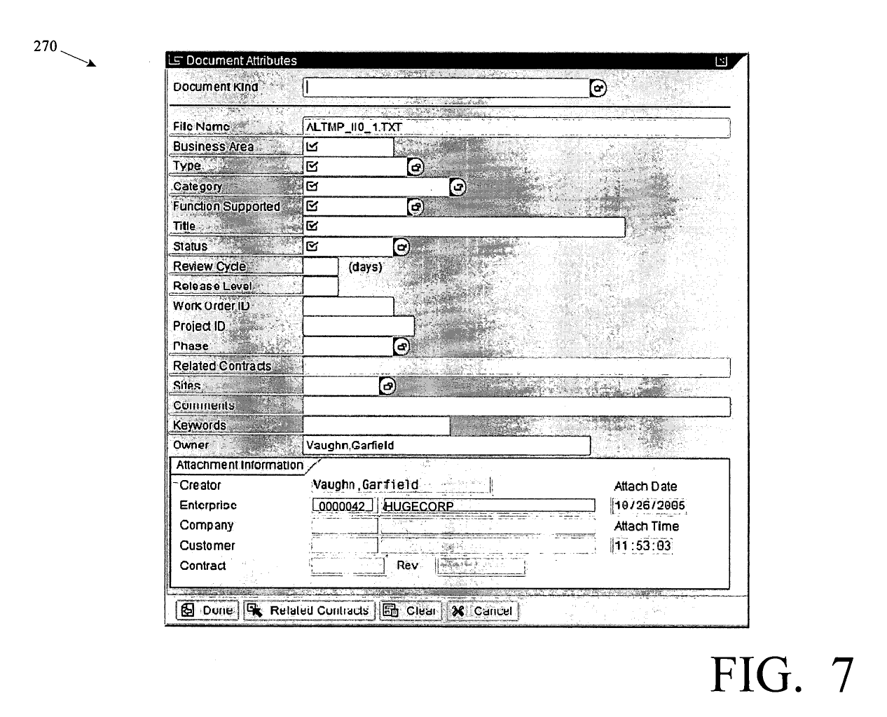

Attributes of a business entity and/or business document may also be modified by attribute assigning system 48 (FIG. 1) in like manner. Attributes of a highlighted business document may be set to their pre-established default values by activating a default attributes button 206 (FIG. 4). In contrast, an attribute function button 232 may be use to open an attribute display window 270 (FIG. 7) for displaying and/or modifying attributes of a business entity and/or business document.

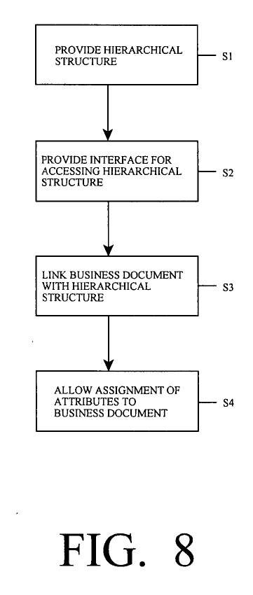

Turning now to FIG. 8, a flow chart of a method according to an embodiment of the present invention is depicted. FIG. 8 will be described with reference to FIGS. 1-3. In first step S1, a hierarchical structure 42 is provided. As indicated above, hierarchical structure has a plurality of levels 110, 120, 130, 140 and 150, wherein each level represents a business entity level (e.g., enterprise, company, customer, contract and revision). In step S2, hierarchical structure interface system 44 provides an interface for accessing the hierarchical structure. The interface provided by hierarchical structure interface system 44 may be a graphical interface as described above, or, in the alternative, any type of interface now known or later developed in the art. In step S3, business document linking system 46 links 312, 322, 332 (FIG. 3) a business document (e.g., Joe's Sales Doc 310, Mary's Delivery Doc 320, Bob's Design Doc 330) with a business entity (e.g., Contract A, Bigco, Revision A2, respectively) in level 110, 120, 130, 140, 150 in hierarchical structure 42 corresponding to the business document. As indicated above, this linking of the business document with the business entity establishes a relationship between the business entity itself as well as any business entities in hierarchical structure 42 that depend from the business entity to which the business document is linked. Finally, in step S4, attribute assigning system 48 allows assignment of attributes to the business document. As stated above, attributes are preferably standardized identifiers for the business document that are that are not related to level 110, 120, 130, 140 and 150 of the business document in hierarchical structure 42.

While shown and described herein as a method and system for storing a business document in an enterprise software application environment, it is understood that the invention further provides various alternative embodiments. For example, in one embodiment, the invention provides a computer-readable/useable medium that includes computer program code to enable a computer infrastructure to reply to an instant message. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer a common document repository service. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for storing a business document in an enterprise application software environment. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for storing a business document in an enterprise software application environment, comprising:
providing a hierarchical structure, the hierarchical structure having a plurality of levels, wherein each level represents a business entity level;
providing an interface for accessing the hierarchical structure;
linking, using the interface, the business document with a business entity in the level in the hierarchical structure corresponding to the business document; and
allowing assignment of attributes that are not related to the level to the business document.

2. The method of claim 1, wherein the plurality of levels include enterprise, company, customer, contract, and revision.

3. The method of claim 1, wherein the attributes include business are a, owner, office location, title and function.

4. The method of claim 1, wherein the enterprise software application environment comprises a Systems, Application and Products (SAP) environment.

5. The method of claim 1, further comprising providing a search engine for retrieving the business document.

6. The method of claim 5, wherein the search engine searches based on the level.

7. The method of claim 5, wherein the search engine searches based on the attributes.

8. A system for storing a business document in an enterprise software application environment, comprising:
a hierarchical structure having a plurality of levels, wherein each level represents a business entity level;
an interface for accessing the hierarchical structure;
means for linking, using the interface, the business document with a business entity in the level in the hierarchical structure corresponding to the business document; and
means for assigning attributes to the business document that are not related to the level.

9. The system of claim 8, wherein the plurality of levels include enterprise, company, customer, contract, and revision.

10. The system of claim 8, wherein the attributes include business are a, owner, office location, title and function.

11. The system of claim 8, wherein the enterprise software application environment comprises a Systems, Application and Products (SAP) environment.

12. The system of claim 8, further comprising a search engine for retrieving the business document.

13. The system of claim 12, wherein the search engine searches based on the level.

14. The system of claim 12, wherein the search engine searches based on the attributes.

15. A program product stored on a computer readable medium for storing a business document in an enterprise software application environment, the computer readable medium comprising program code for causing a computer system to perform the following steps:
provide a hierarchical structure, the hierarchical structure having a plurality of levels, wherein each level represents a business entity level;
provide an interface for accessing the hierarchical structure;
link, using the interface, the business document with a business entity in the level in the hierarchical structure corresponding to the business document; and
allow assignment of attributes that are not related to the level to the business document.

16. The program product of claim 15, wherein the plurality of levels include enterprise, company, customer, contract, and revision.

17. The program product of claim 15, wherein the attributes include business area, owner, office location, title and function.

18. The program product of claim 15, wherein the enterprise software application environment comprises a Systems, Application and Products (SAP) environment.

19. The program product of claim 15, wherein the computer readable medium further comprises program code for causing the computer system to provide a search engine for retrieving the business document.

20. The program product of claim 19, wherein the search engine searches based on the level.

21. The program product of claim 19, wherein the search engine searches based on the attributes.

22. A method for deploying an application for storing a business document in an enterprise software application environment, comprising:
providing a computer infrastructure being operable to:
provide a hierarchical structure, the hierarchical structure having a plurality of levels, wherein each level represents a business entity level;
provide an interface for accessing the hierarchical structure;
link, using the interface, the business document with a business entity in the level in the hierarchical structure corresponding to the business document; and
allow assignment of attributes that are not related to the level to the business document.
